(19) United States
(12) Patent Application Publication
(10) Pub. No.: US 2020/0240826 A1
(43) Pub. Date: Jul. 30, 2020

(54) FLUID END OF LIFE SENSORS

(71) Applicant: Battelle Memorial Institute, Columbus, OH (US)

(72) Inventors: Matthew Vaughan, Columbus, OH (US); Brett Burton, Columbus, OH (US); David Bartholomew, Columbus, OH (US); Trevor Tallos, Columbus, OH (US); David Chase, Columbus, OH (US); Bryan D. Balaban, Grove City, OH (US); Jackson Brengman, Lancaster, OH (US)

(21) Appl. No.: 16/259,124

(22) Filed: Jan. 28, 2019

(51) Int. Cl. G01F 23/292; G01F 23/296; G08B 21/18; G08B 5/36; G08B 5/22

(52) U.S. Cl. CPC G01F 23/2925; G01F 23/296; G08B 5/225; G08B 5/36; G08B 21/182

(57) ABSTRACT

In a liquid level monitor for use with a liquid container of a liquid-consuming device, a light source transmits a light beam into the liquid container at a non-normal angle of incidence respective to a wall of the liquid container. A photodetector is positioned in the path of one of (i) the light beam after passing through the liquid container when the light beam is not refracted by liquid in the liquid container and (ii) the light beam after passing through the liquid container when the light beam is refracted by liquid in the liquid container. In another approach, the sensor for detecting empty includes a vibrator and a vibration sensor, and an electronic processor is programmed to determine whether the liquid container is empty of liquid based on the detected vibration of the liquid container.

### BACKGROUND

The following relates to the fluid monitoring arts and related arts.

Various devices employ a liquid in a liquid container as a consumable. For example, a hand sanitizer dispenses a liquid sanitizer from a container, or soap dispenser dispenses a liquid soap from a container, or lamp oil that is consumed by an oil lamp comprising a wick extending into the oil of the container, or so forth.

The liquid in a consumable liquid container eventually runs out, at which point the liquid container must be refilled (if the container is refillable) or replaced (if the liquid container is a disposable consumable item in which the container is replaced along with the liquid). In practice, however, it can be difficult to ensure such replacement is done in a timely manner. It can be easy to forget to check whether a liquid container is empty, and if the liquid runs out during operation of the device that consumes the liquid this can be inconvenient and/or introduce time delays and/or additional expense.

### BRIEF SUMMARY

In accordance with some illustrative embodiments disclosed herein, a liquid level monitor is disclosed for use in conjunction with a liquid container of a liquid-consuming device. The liquid level monitor comprises a light source and a photodetector. The light source is positioned to transmit a light beam into the liquid container of the liquid-consuming device at a non-normal angle of incidence respective to a wall of the liquid container upon which the light beam impinges. The photodetector is disposed at a position which is in the path of one of (i) the light beam after passing through the liquid container when the light beam is not refracted by liquid in the liquid container and (ii) the light beam after passing through the liquid container when the light beam is refracted by liquid in the liquid container.

In accordance with some illustrative embodiments disclosed herein, a method is disclosed of monitoring whether a liquid container is empty. The method comprises: directing a light beam into the liquid container; detecting whether the light beam passes through a chord of a cross-section of the liquid container; and outputting, via a visual indicator or a wireless transmitter or transceiver, an indication that the liquid container should be refilled or replaced if the light beam is one of (i) detected to pass through the chord of the cross-section of the liquid container or (ii) not detected to pass through the chord of the cross-section of the liquid container.

In accordance with some illustrative embodiments disclosed herein, a liquid level monitor is disclosed for use in conjunction with a liquid container of a liquid-consuming device. The liquid level monitor comprises a vibrator, a vibration sensor, and an electronic processor. The vibrator is positioned to induce a vibration of the liquid container of the liquid consuming device. The vibration sensor is positioned to detect the vibration of the liquid container. The electronic processor is programmed to determine whether the liquid container is empty of liquid based on a frequency and/or amplitude of the detected vibration of the liquid container.

### BRIEF DESCRIPTION OF THE DRAWINGS

FIGS. 1, 2, and 3 diagrammatically illustrate perspective, side, and front views, respectively, of a liquid container and monitor device.

FIG. 4 diagrammatically shows Section S-S indicated in FIG. 3 according to a first embodiment.

FIG. 5 diagrammatically plots the photodiode voltage of the photodiode of the embodiment of FIG. 4 as a function of liquid level in the liquid container.

FIGS. 6, 7, and 8 diagrammatically show a mobile device running an application program (“app”) monitoring the liquid level in the liquid container of FIGS. 1-3, where: FIG. 6 shows a suitable display when liquid is available;

FIG. 7 shows a suitable display when the liquid container is empty; and

FIG. 8 shows a suitable display when the liquid container is not installed.

FIG. 9 diagrammatically shows infrared mapping of the impact of the liquid container on the beam shape.

FIG. 10 diagrammatically shows Section S-S indicated in FIG. 3 according to a second embodiment.

### DETAILED DESCRIPTION

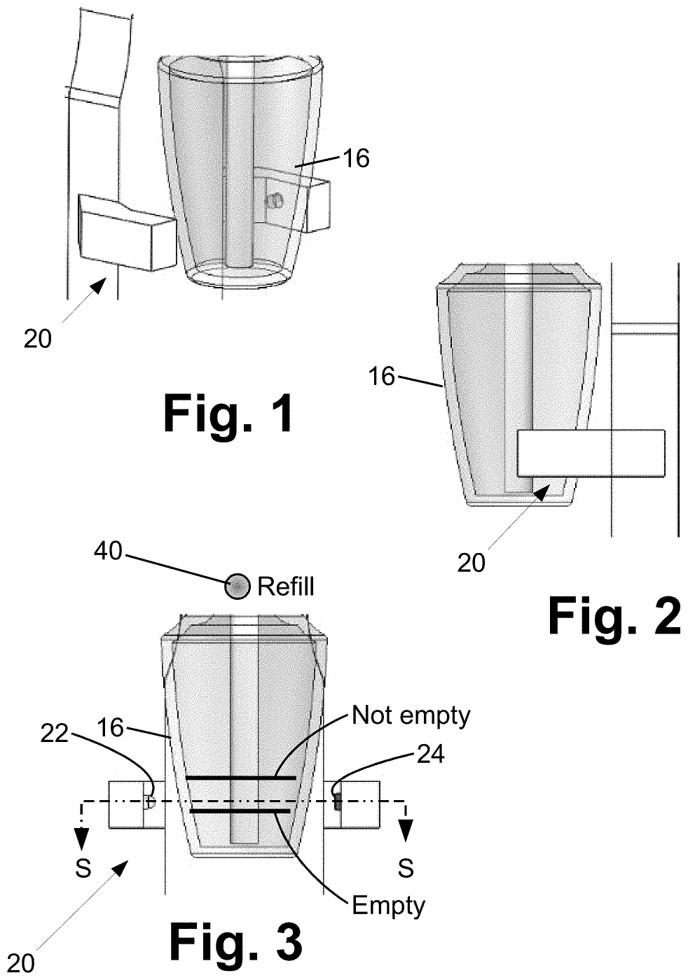

With reference to FIGS. 1-3, perspective (FIG. 1), side (FIG. 2), and front (FIG. 3) views, respectively, of a liquid container and monitor device are shown. A liquid container 16 is transparent or translucent, so that the user can visually see the level of liquid remaining in the container 16. The liquid in the liquid container 16 is consumed by a device or apparatus (not shown), e.g. if the liquid container 16 contains hand sanitizer then the container 16 is suitably designed to connect with a hand sanitizer dispenser; if the liquid container 16 contains liquid soap then the container 16 is suitably designed to connect with a soap dispenser; if the liquid container 16 contains lamp oil then the container 16 is suitably designed to connect with an oil lamp with its wick extending into the oil in the container; or so forth.

A sensor assembly 20 is provided for detecting whether the liquid container 16 is empty. The term “empty” as used herein denotes the amount or level of liquid in the liquid container 16 is low enough to cause the sensor assembly 20 to indicate the container 16 is empty. For example, the sensor assembly 20 may be a binary level indicator that outputs a first value, corresponding to “not empty” when the level of liquid in the container 16 is above a threshold level, and outputs a second value, corresponding to “empty” when the level of liquid in the container 16 is lower than the threshold level. This is diagrammatically shown only in FIG. 3, where the threshold is indicated by the horizontal level of the Section S-S line, and the indicated level labeled “Not empty” is above this threshold while the indicated level labeled “Empty” is below this threshold. The threshold is preferably chosen to be relatively close to the bottom of the container 16, as shown in FIG. 3, so that the “Empty” indication is triggered when the liquid level is close to the bottom of the container 16 (that is, the liquid is almost gone); however, the threshold is some distance above the very bottom of the container 16 so that there is still some liquid remaining in the container 16 when the “Empty” indication is triggered, thereby providing the user with some time cushion to replace or refill the liquid container 16 before completely running out of liquid. In some embodiments, hysteresis is incorporated into the level indicator output algorithm. In one approach, different thresholds are used for “Empty” and “Not empty” to account for the effect of surface tension at the liquid/air interface.

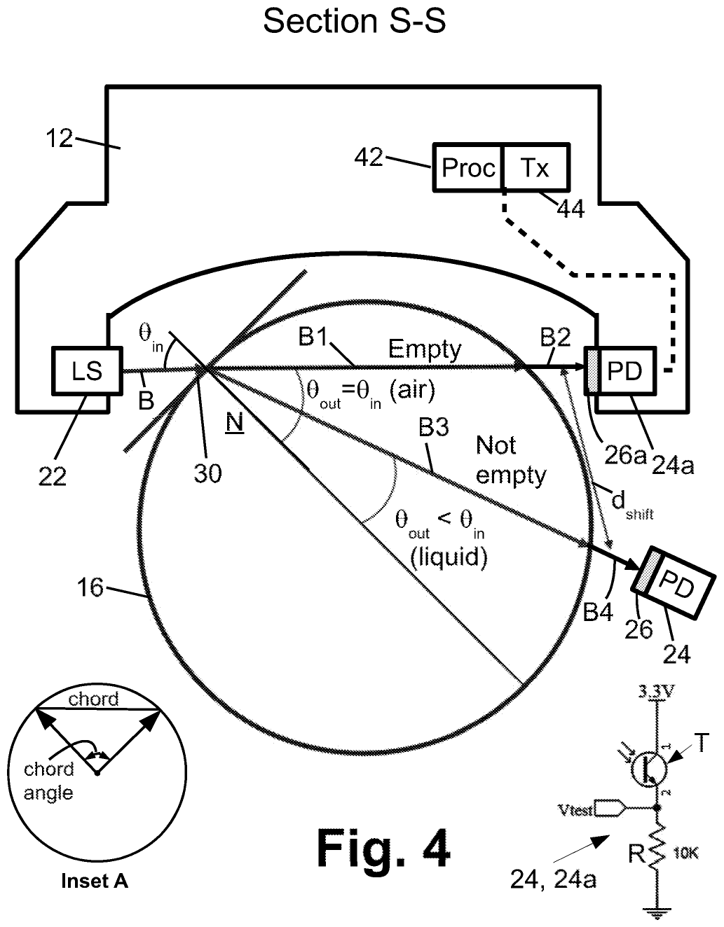

The sensor assembly 20 can take various forms. In general, the sensor assembly 20 includes a source 22 and a detector 24 (labeled only in FIG. 3; see also FIG. 4). In some preferred embodiments, the sensor assembly 20 employs optical sensing in which a color, time of flight, or intensity of light differs when the light is passing through the liquid (such that the container 16 is not empty) compared with when the light is passing through air (such that the container is empty). However, existing sensors of this type have some substantial difficulties when applied for detecting whether a liquid container 16 is empty of liquid. One problem relates to sensitivity and robustness. For many applications, such as soap dispensers, the liquid container 16 is a consumable item (replaced rather than refilled), and is desired to be an inexpensive disposable item. As such, manufacturing tolerances for the liquid container 16 are usually not strict, and there can be wide item-to-item variation in characteristics of the container 16 such as its roundness (assuming it is designed to have a circular cross-section as in the embodiment of FIGS. 1-3), its precise placement when installed, the smoothness and precise contouring of its walls, and so forth. Because of this, the optically sensed color, time of flight, or other characteristics can vary significantly from one container to another.

A further problem is that the sensor assembly 20 can interfere with the installation (and subsequent removal/replacement) of the liquid container 16. The sensor assembly 20 is suitably placed near the bottom of the container 16 in order to operate at an empty/not empty threshold level that is near the bottom of the container 16. But, depending upon the installation design, the user may grip the container 16 near its bottom when screwing it into or out of a threaded or bayonet connection or other connector used for connecting the liquid container 16 during installation.

With continuing reference to FIGS. 1-3 and with further reference to FIG. 4, these difficulties are addressed in an illustrative sensor assembly 20 which leverages the different refraction angle at a container/air boundary compared with a container/liquid boundary. In this sensor assembly 20, the source 22 comprises a laser diode, light emitting diode (LED) with focusing lens, or other light source (LS) 22 that outputs a light beam B, and the detector 24 comprises a photodetector 24 with optional spectral filter 26. For example, the filter 26 can be designed to remove stray light and/or may be a bandpass filter that preferentially passes a center wavelength of light emitted by the light source 22. The light source 22 is disposed on or in the soap dispenser, hand sanitizer dispenser, or other device to which the container 16 is installed, and is positioned to transmit the light beam B into the liquid container 16 at a non-normal angle of incidence θᵢₙ respective to a wall 30 of the container 16 upon which the light beam B impinges. The angle of incidence θᵢₙ is measured off the surface normal, denoted as N in FIG. 4. According to Snell's law, the output angle, θₒᵤₜ of the light beam inside the container 16 after passing through the wall 30 is given by:

n₁ sin(θᵢₙ)=n₂ sin(θₒᵤₜ) (1)

Outside the container 16 the ambient medium is air, having refractive index n₁=1.00. Inside the container 16, the medium into which the light beam enters is either air (if the container is empty, by which it is meant that the liquid level is below the threshold indicated by Section S-S in FIG. 3) or the medium is the liquid with which the container 16 is (initially) filled (e.g., liquid soap in the case of a liquid soap container, sanitizer fluid in the case of a container for use with a hand sanitizer, or so forth). If the medium into which the light beam B enters is air, having n₁=1.00, then θₒᵤₜ=θᵢₙ and as seen in FIG. 4 the beam B1 inside the container 16 continues in the same direction after passing through the wall 30 as the beam B was traveling before passing through the wall 30. Likewise, at the opposite wall when the beam B1 passes back outside of the container 16 as beam B2, it remains traveling in the same original direction θᵢₙ. The photodetector 24 is disposed at a position which is not in the path of the light beam B2 after passing through the liquid container 16 when the light beam B1 is not refracted by liquid in the container 16 (example of photodetector 24 shown in FIG. 4).

On the other hand, if the medium into which the light beam enters is the liquid (because the container is not empty, and the liquid level is above the threshold indicated by Section S-S in FIG. 3), then the refractive index n₂ of the medium inside the container is greater than 1.00. By way of non-limiting illustrative example, the liquid may have a refractive index of n₂˜1.4. Using these values, and assuming θᵢₙ=45° (as in the illustrative example of FIG. 4), solving Equation (1) for θₒᵤₜ yields θₒᵤₜ=30.3°. In general, since a liquid virtually always has a larger refractive index than air (n₂>n₁), it follows from Equation (1) that θₒᵤₜ<θᵢₙ and the light beam B3 passing through the container 16 is bent toward the surface normal N. For these values, and assuming the container has a circular cross-section of diameter 30 mm, the light beam B3 (for liquid) passes out of the container 16 at a distance d_{shift}=8 mm away from where the beam B2 (for air) passes out. Because of this large shift, the photodetector 24 is in the path of the light beam after passing through the container 16 when the light beam B3 is refracted by liquid in the (not empty) container 16.

Because of the large shift (d_{shift}) thus obtained between empty (passing through air) and not empty (passing through liquid), the sensor assembly 20 of FIG. 4 is robust against typical item-to-item variations in the liquid container 16. So long as these changes are not so large that the “straight-through” beam sequence B→B1→B2 hits the photodetector 24, the sensor should provide accurate indication of empty or not empty. Moreover, this “straight-though” beam is not affected by variations in the tilt of the wall 30 of the liquid container 16 upon which the light beam B impinges (since θₒᵤₜ=θᵢₙ regardless of the tilt of the wall 30) and is likewise insensitive to the tilt of the wall at the opposite side (at the beam B1→beam B2 transition). The tilt of the wall 30 will affect the exact angle θₒᵤₜ of the beam B3 in the “not empty” condition, but so long as the beam width is large enough to hit the photodetector 24 even with tilt variation, the sensor assembly will work properly.

In an alternative embodiment, the photodetector 24 (and optional filter 26) arranged to detect the refracted beam B4 in the “not empty” case is replaced by a photodetector 24a (and optional filter 26a) that is arranged to detect the “through” beam B2 in the “empty” case. An advantage is that the sensor assembly 20 can be positioned nearer to an edge of the liquid container 16. This is shown in FIG. 4 by the position of the dispenser 12 so that the arms are positioned to mount photodetector 24a. By contrast, when using the position of photodetector 24 to detect the refracted beam B4, the dispenser 12 would need to be rotated around and have longer arms to mount both the source 22 and detector 24 (not shown in FIG. 4).

The light source 22 is positioned such that the path of the light beam passing through a circular cross-section of the liquid container 16 when the light beam is not refracted by liquid in the container 16 (that is, the beam B1 shown in FIG. 4) defines a chord of the circular cross-section. Similarly, the path of the light beam passing through the circular cross-section of the liquid container 16 when the light beam is refracted by liquid in the container 16 (that is, the beam B3 shown in FIG. 4) defines another (i.e. refracted) chord of the circular cross-section. If the sensor assembly 20 is placed near the edge of the container, then this chord will have a small angle. (As diagrammed in “Inset A” of FIG. 4, the angle of a chord of a circle is the arc of the circle that is subtended by the chord. The term “chord angle” is also used herein to denote this angle of the chord. The chord can also be similarly defined in the context of a cross-section that is not perfectly circular, e.g. which is oval or has one or more indentations or protrusions and/or so forth). If the chord angle is small, then the light source 22 and photodetector 24 or 24a are both positioned near an edge of the container 16, and hence will minimally interfere with user access to the container 16 when installing or removing the container 16 from the device with which it is installed. This is most easily achieved in embodiments employing the photodetector 24a since the refraction producing refracted beam B3 drives the beam deeper “into” the container. In some embodiments, the light source 22 is positioned such that the path of the light beam passing through a circular cross-section of the liquid container when the light beam is not refracted by liquid in the container (that is, beam B1) defines a chord of the circular cross-section in which the angle of the chord is less than or equal to 100 degrees. In some even more advantageous embodiments, the angle of the chord is less than or equal to 55 degrees. In the illustrative example of FIG. 4, the angle of the chord is 45 degrees.

In an illustrative example shown in the lower right inset of FIG. 4, in this illustrative embodiment the photodetector 24 (or, in the alternative embodiment, the photodetector 24a) is a phototransistor (T) that is connected to +3.3V via a pull up resistor (R), which is a 10 k-ohm resistor in the illustrative example. The output (Vtest) has a low voltage when the phototransistor (T) is illuminated by light (because the phototransistor “shorts” the line to ground), and high voltage when the phototransistor (T) is not illuminated by light (the phototransistor remains open). This is merely an illustrative example, and other designs for the photodetector 24 (or photodetector 24a) are contemplated, e.g. using a photodiode, phototransistor, or other photonic device in a suitable biasing circuit topology.

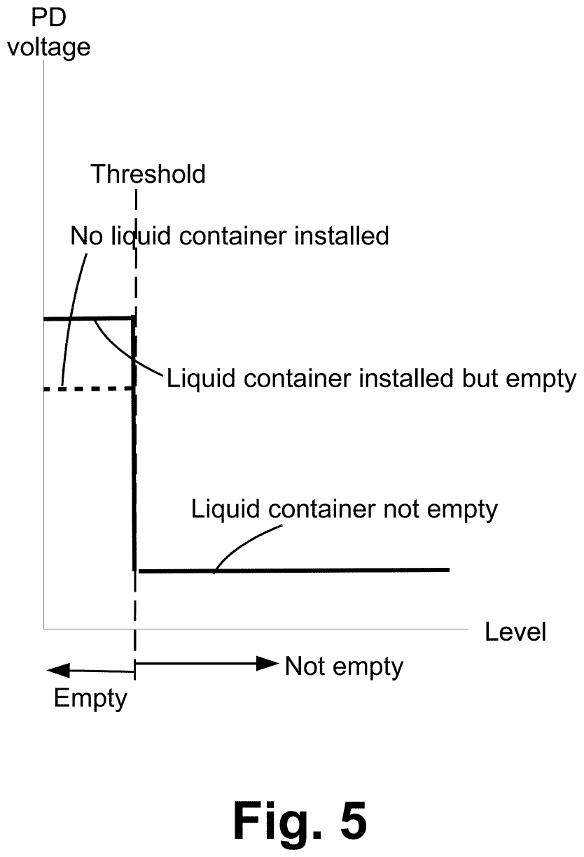

With reference now to FIG. 5, the photodiode voltage measured by the photodetector 24 of the embodiment of FIG. 4 is shown as a function of liquid level in the container 16. As seen, at the empty/not empty threshold (corresponding to the horizontal level of the Section S-S in FIG. 3), the voltage transitions from a low voltage value for liquid level above the threshold (because here the beam is following the refracted beam B3 of FIG. 4 so that the photodetector 24 is in the path of the refracted beam B3 and is illuminated by the light beam B4) to a high voltage value for liquid level below the threshold (because here the beam is following the not-refracted path of beam B1→B2 of FIG. 4 so that the photodetector 24 is not in the path and is not illuminated by the light beam B2).

If using the photodiode 24a positioned in the unrefracted light path B1→B2 of FIG. 4, and the transistor-based detector of FIG. 4, lower right inset is used, then the voltages will be reversed, i.e. when the container is empty the light beam B2 illuminates photodetector 24a producing a low voltage; whereas when the container is not empty the refracted light beam B4 does not illuminate the photodetector 24a leading to a high voltage.

A further advantage of the sensor assembly of FIG. 4 is that, depending upon the light absorption of the empty container 16, it may be possible to distinguish between the cases of (1) an installed but empty container 16, and (2) not having any container installed at all. As diagrammatically shown in FIG. 5 for the case of using the photodetector 24 positioned to detect the refracted beam, in the latter case (no container installed) the output of the photodetector 24 is lower, indicating the light beam is detected at a beam intensity that is greater than a threshold value corresponding to the liquid container not being installed. More generally, an indication that liquid container is not installed is based on the light beam being detected at an intermediate value between being detected to pass through the chord of the cross-section of the liquid container and being not detected to pass through the chord of the cross-section of the liquid container. This can be particularly advantageous in the case of devices such as soap dispensers that may be installed in a commercial location where liquid containers may be removed by vandals or thieves.

With reference back to FIGS. 3 and 4, if the sensor assembly 20 detects the liquid container 16 is empty then this can be indicated in various ways. In one approach (shown in FIG. 3), an LED indicator 40 is provided on the device in which the container 16 is installed, which is lighted if the sensor assembly 20 detects the liquid container 16 is empty. The LED 40 may be suitably labeled, e.g. by text indicating “Refill” as shown in FIG. 3. The LED 40 may for example be driven by an electronic processor 42 (e.g., a microprocessor or microcontroller) that is operatively connected to receive the output from the photodetector 24 and is programmed to control the LED 40.

The LED 40 or other indicator mounted on the device in which the container 16 is installed may provide a visual cue to the user indicating the liquid container 16 need to be refilled or replaced (depending on design). However, the LED 40 will not be visible to the user if the device is placed in an inconspicuous or hidden location, such as may be the case, for example, in a bathroom soap dispenser that may be installed underneath the sink to improve cosmetic appearance of the bathroom.

Accordingly, in some embodiments the output is instead (or additionally) provided to a mobile device (e.g. a cellular telephone, i.e. cellphone, tablet computer, or so forth) by way of wireless communication. To this end, as shown in FIG. 4, a transmitter or transceiver 44 is disposed on or in the device in which the container 16 is installed, and the transmitter or transceiver 44 is operatively connected to output a wireless signal indicating an output of the photodetector 24. The transmitter or transceiver 44 typically operates under control of the electronic processor 42. The transceiver or transmitter 44 may, for example, be a Bluetooth™ transmitter or transceiver, a WiFi transceiver, and/or so forth.

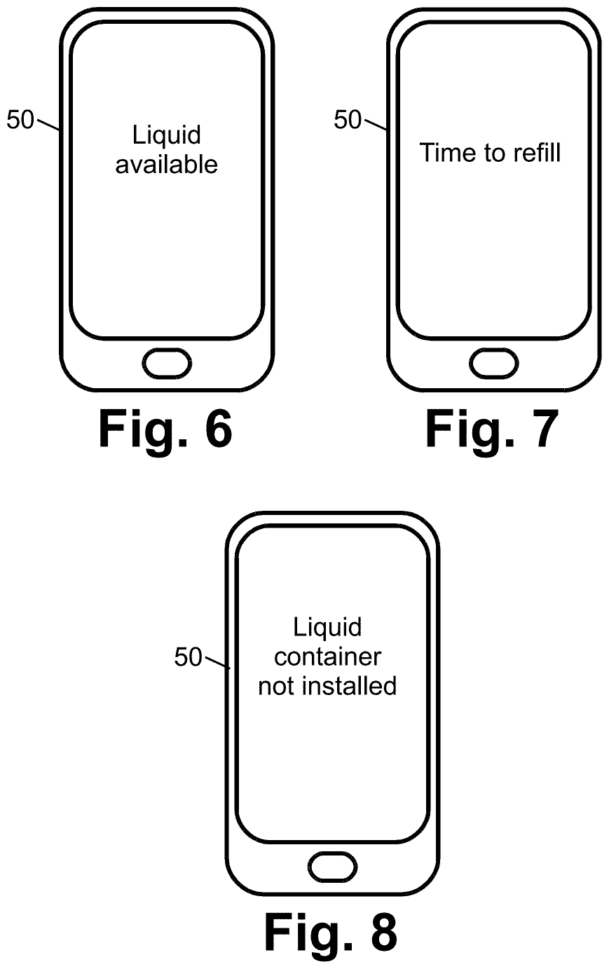

With continuing reference to FIG. 4 and with further reference to FIGS. 6-8, a mobile device 50 in the illustrative form of a brick cellphone is loaded with an application program (“app”) that when run on the mobile device 50 receives the wireless signal from the transmitter or transceiver 44 using a complementary Bluetooth™, WiFi, or other wireless radio of the mobile device 50, and presents a suitable informative display, such as “Liquid available” (FIG. 6, corresponding to the sensor assembly 20 indicating the liquid container 16 is not empty), or “Time to refill” (FIG. 7, corresponding to the sensor assembly 20 indicating the liquid container 16 is empty). In embodiments in which the sensor assembly 20 distinguishes between the container being empty versus not installed at all, the mobile device 50 running the app may if appropriate display “Liquid container not installed” (FIG. 8, corresponding to the sensor assembly 20 indicating the liquid container is not installed). These designations are may also be tied to a particular device in which the liquid container 16 is installed, e.g. determined based on a device identification (device ID) code transmitted by the transmitter or transceiver 44 under control of the electronic processor 42, or by some other device identification mechanism. It will be appreciated that the specific messages presented in FIGS. 6-8 are non-limiting illustrative examples, and may be tailored to the type of liquid/device, e.g. for a soap dispenser the example notification of FIG. 6 may be replaced by something like “Soap dispenser is operational”; the notification of FIG. 7 may be replaced by something like “Soap nearly empty—Time to refill”; and the notification of FIG. 8 may be replaced by something like “Soap container not installed”.

In the embodiment of FIGS. 1-5, the photodetector 24 is disposed at a position which is in the path of the light beam after passing through the liquid container when the light beam is not refracted by liquid in the container. As explained herein, this arrangement has certain advantages, e.g. the sensor assembly 20 can be positioned near an edge of the liquid container 16. However, the opposite arrangement is alternatively contemplated, that is, an arrangement in which the photodetector is at a position which is in the path of the light beam after passing through the liquid container when the light beam is refracted by liquid in the container.

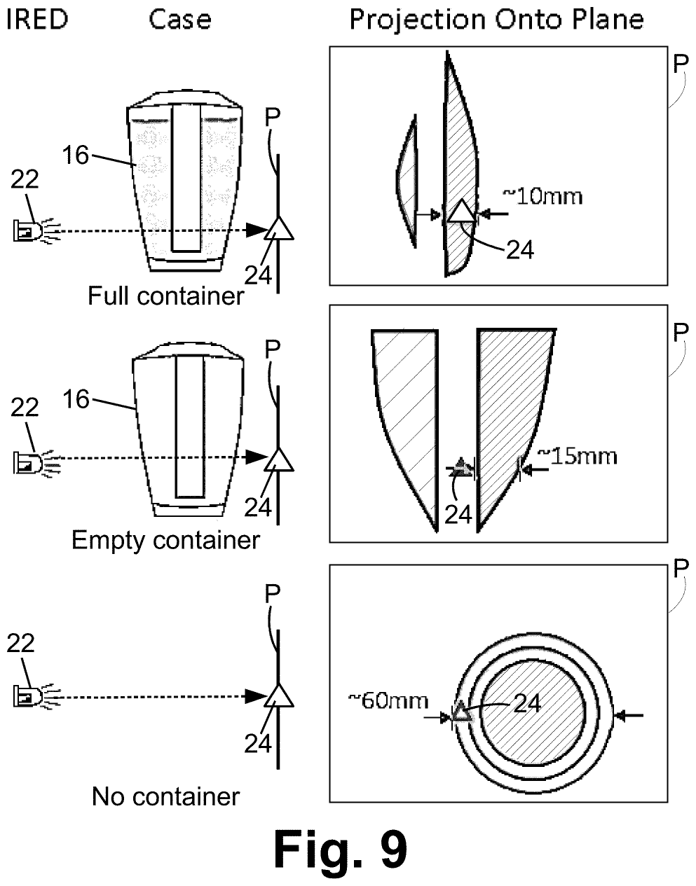

With reference now to FIG. 9, infrared mapping was performed to assess the impact of the liquid container on the beam shape, using the arrangement employing the photodetector 24 arranged to detect the refracted beam B3→B4 and using the transistor based photodetector topology of FIG. 4, lower right inset. FIG. 9 shows three cases: the liquid container 16 is not empty (top drawing; labeled as a “full” container); the liquid container 16 is empty (middle drawing); and the liquid container 16 is missing (bottom drawing; labeled “No container”). The left side of each drawing illustrates the arrangement of the light source 22 and photodetector 24 relative to the liquid container 16, along with an indication of a detection plane P at which an infrared detector array is placed. The right side of each drawing diagrammatically shows the infrared intensity distribution using shading (darker shading indicates higher infrared intensity). The location of the photodetector 24 in the plane P is also indicated in the right side diagram. In this illustrative experiment, the light source 22 is an infrared emitter, and the distance between the infrared emitter 22 and the plane P is 70 mm.

As particularly seen in comparing the middle drawing (empty liquid container) versus the lower drawing (no liquid container), the presence of the liquid container 16 significantly changes the distribution of light. In the case of no container (bottom drawing), the infrared distribution is radially symmetrical with highest intensity at the center, and a diameter of about 60 mm. By contrast, in the case of the empty container (middle drawing), the container horizontally breaks the beam up into two lobes separated by a low intensity central region, and also bends the two lobes upward. If the photodetector 24 is located in the low intensity central region between the two lobes, then a high sensor voltage is measured. Table 1 lists the sensor voltages measured by the photodetector 24 in each case. As can be seen, due to the bifurcated intensity distribution introduced by the container 16 coupled with placement of the photodetector 24 in the gap between the two lobes in the “no container” case, a strong signal difference is seen between the empty container and no container cases, thereby providing high discriminative capability between these two cases. In general, when the liquid container is not installed the detected light beam is usually expected to be at an intermediate value between being detected to pass through the chord of the cross-section of the liquid container and being not detected to pass through the chord of the cross-section of the liquid container (i.e. between the empty and not empty readings). Such ability to distinguish whether the container is empty or missing may be useful, for example, in a public location in which liquid containers may be removed by vandals or the like.

TABLE 1

| Case | Sensor voltage |
|---|---|
| Non-empty container | 0.185 V |
| Empty container | 3.07 V |
| No container | 1.87 V |

The illustrative example of the sensor assembly 20 shown in FIGS. 1-4 has certain advantages, as discussed hereinabove. However, the sensor assembly 20 operates on the assumption that the liquid container 16 is mounted or positioned in a fixed design-basis orientation. However, some liquid containers may be intended for use in different orientations. For example, a hand sanitizer may be intended for use in a vehicle, or a hand sanitizer or soap dispenser may have a swivel or gimbal mount via unit (including the attached liquid container 16) can be rotated about at least one axis. In these cases, the assumption of a fixed design-basis orientation is no longer valid, and the level-based sensor assembly of FIG. 4 may be inoperative and/or unreliable.

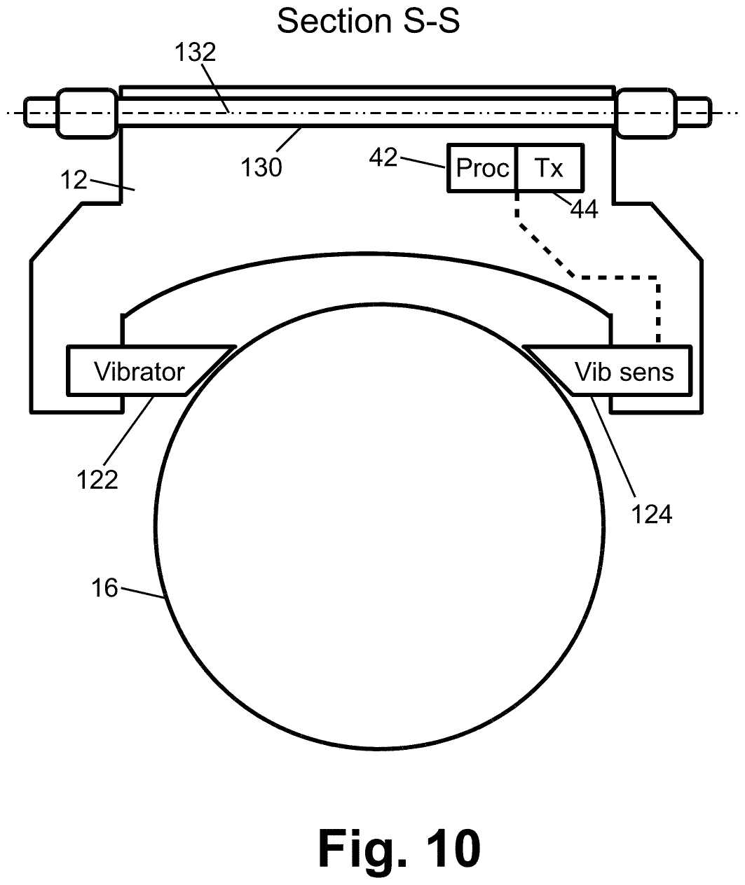

With reference now to FIG. 10, another embodiment of the sensor assembly 20 is shown, which does not rely upon the assumption of a fixed design-basis orientation. This example is illustrated by way of the same Section S-S shown in FIG. 3; however, in this embodiment the source 22 of the sensor assembly comprises a vibrator 122 positioned to induce a vibration of the liquid container 16. The detector 24 comprises a vibration sensor 124 positioned to detect the vibration of the liquid container 16. The electronic processor 42 is programmed to determine whether the liquid container 16 is empty of liquid based on a frequency and/or amplitude of the detected vibration of the liquid container. The resulting output may be displayed via the LED 40 shown in FIG. 3 and/or ported off wirelessly by way of the wireless transmitter or transceiver 44 as already described. It may be noted that in this embodiment the liquid container 16 does not need to be transparent or translucent as no light is passed into or out of the container.

The vibrator 122 can be in contact with the container 16, or can be at a standoff from the container 16, as long as the vibrator 122 can induce the vibration in the container 16. As an example of a vibrator 122 with a standoff, the vibrator 122 could be an ultrasonic transducer that transmits ultrasonic waves so as to induce the vibration of the liquid container 16. In general, the induced vibration may be an impulse force or a steady state frequency. The vibration sensor 124 can be in contact with the container 16, or can be at a standoff from the container 16, as long as the vibration sensor 124 can detect the vibration of the container 16. As an example of a vibration sensor 124 with a standoff, the vibration sensor 124 could be an ultrasonic transducer that induces a voltage in response to the ultrasonic waves generated by the vibrating container 16. Advantageously, the vibrator 122 and vibration sensor 124 can be variously located, as there is no required position. Preferably, neither component is located on one of nodes of the vibrational mode shape of the vibrations induced by the vibrator 122.

In one embodiment, the vibration sensor 124 (and/or post-processing of the detected vibration by the processor 42) measures the frequency response of the container 16 to the induced vibration. The shift in natural frequency (from an impulse force), and/or the change in vibrational amplitude at a given excitation frequency, can be used as indicative of whether the container 16 is empty or not empty. This is due to the vibration amplitude and frequency being dependent upon mass and density characteristics of the container 16. The excitation frequency is preferably targeted at a frequency that provides a strong difference in amplitude between the empty and not empty states of the container 16. The natural frequency and/or vibrational amplitude of the empty versus not empty container can be determined empirically by measuring the vibrational response to various vibrator inputs, or can be computed using mass-and-spring constant modeling approaches using parameters such as the container mass, the mass density of the liquid, volumes, and so forth.

Advantageously, the vibrational response is expected to be substantially unaffected by orientation of the container 16. Hence, for example, the liquid container 16 can have a swivel or gimbal mount (e.g. illustrative swivel mount 130 shown in FIG. 10) via which the liquid container 16 can be rotated about at least one axis 132, and the vibrational sensor assembly of FIG. 10 will operate to assess whether the container 16 is empty for a range of different rotational positions. Preferably, during empirical calibration of the vibrational sensor assembly, test measurements of the vibrational response are taken at different rotational positions spanning the expected range of positions during actual use, so as to ensure sufficient robustness of the sensing against such orientation variations. In some embodiments, the output of the vibration sensor 124 may be filtered or gated to remove vibrational signal components that are attributable to sudden movement of the container 16. Such filtering or gating may be particularly useful in the case of use in an environment such as a vehicle in which sudden movements can be expected.

Similarly to the optically-based embodiment of FIG. 4, the vibration-based embodiment of FIG. 10 can also detect if the liquid container 16 is missing. In this case, the vibrational response will typically be a null response, since the liquid container 16 is the medium via which vibrations produced by the vibrator 122 are transmitted to the vibration sensor 124. Hence, if there is no liquid container installed in the liquid-consuming device then a null response will typically be detected, and this can be used to provide an indication that no container is installed, e.g. as described previously with reference to FIGS. 5, 8, and 9 (bottom drawing).

It will be appreciated that the disclosed approaches are applicable to detecting whether a liquid container that is connected with a dispenser (or other liquid-consuming device) is empty. Whether a liquid container is empty is monitored as follows. The liquid-consuming device is operated and consumes liquid contained in the liquid container 16. For example, in the case of a hand sanitizer, the dispenser may be a manual pump and the liquid is hand sanitizer liquid. In the case of a soap dispenser, the dispenser may again be a manual pump, and the liquid is liquid soap. In either case, an automatic pump operated by a proximity sensor may replace the manual pump to provide hands-free dispensing of the hand sanitizer liquid or the liquid soap, respectively. As yet another example, in the case of an oil lamp the liquid container may be a lamp oil container, and the liquid-consuming device is an oil lamp (e.g. comprising a wick that extends into the lamp oil container). Again, these are merely non-limiting illustrative examples. Using the embodiment of FIG. 4, a light beam is directed by light source 22 through a chord of a cross-section of the liquid container (e.g., the chord along which the beam B1 of FIG. 4 travels), and the photodetector 24 detects whether the light beam passes through the chord of the cross-section of the liquid container (or, in an alternative embodiment, detects whether the light beam passes through a refractive path resulting from refraction of the beam by liquid in the container). An indication that the fluid dispenser should be refilled is outputted based on whether the light beam is detected, e.g. outputted via a visual indicator or a wireless transmitter or transceiver.

The preferred embodiments have been illustrated and described. Obviously, modifications and alterations will occur to others upon reading and understanding the preceding detailed description. It is intended that the invention be construed as including all such modifications and alterations insofar as they come within the scope of the appended claims or the equivalents thereof.

1. A liquid level monitor comprising:
a dispenser for dispensing hand sanitizer liquid or liquid soap contained in a liquid container configured to connect with the dispenser;
a light source positioned on the dispenser to transmit a light beam into the liquid container of the dispenser at a non-normal angle of incidence respective to a wall of the liquid container upon which the light beam impinges;
a photodetector disposed on the dispenser at a position which is in the path of one of (i) the light beam after passing through the liquid container when the light beam is not refracted by hand sanitizer liquid or liquid soap in the liquid container and (ii) the light beam after passing through the liquid container when the light beam is refracted by hand sanitizer liquid or liquid soap in the liquid container;
a wireless transmitter or transceiver operatively connected to output a wireless signal indicating an output of the photodetector; and
a mobile device comprising a cellular telephone (cellphone) or tablet computer, the mobile device having loaded thereon an application program (app) operative to cause the mobile device to wirelessly receive the wireless signal indicating the output of the photodetector and based on the received wireless signal to:
display an indication that the liquid container is empty in response to the output of the photodetector indicating that the liquid container is empty, or
display an indication that the liquid container is not installed in response to the output of the photodetector indicating that the liquid container is not installed.

2. (canceled)

3. The liquid level monitor of claim 1 further comprising a light emitting diode (LED) indicator disposed on the dispenser and indicating that the liquid container is not empty by not lighting the LED disposed on the liquid-consuming device.

4-6. (canceled)

7. The liquid level monitor of claim 1 wherein the photodetector is disposed at a position which is in the path of the light beam after passing through the liquid container when the light beam is refracted by liquid in the liquid container.

8. The liquid level monitor of claim 1 wherein the photodetector is disposed at a position which is in the path of the light beam after passing through the liquid container when the light beam is not refracted by liquid in the liquid container.

9. The liquid level monitor of claim 8 wherein the light source is positioned such that the path of the light beam passing through a circular cross-section of the liquid container when the light beam is not refracted by liquid in the liquid container defines a chord of the circular cross-section wherein the angle of the chord is less than or equal to 100 degrees.

10. The liquid level monitor of claim 9 wherein the light source is positioned such that the path of the light beam passing through a circular cross-section of the liquid container when the light beam is not refracted by liquid in the liquid container defines a chord of the circular cross-section wherein the angle of the chord is less than or equal to 55 degrees.

11. The liquid level monitor of claim 1 further comprising a spectral filter disposed in front of the photodetector.

12-20. (canceled)

21. The liquid level monitor of claim 7 wherein the light source is an infrared emitter and the photodetector is disposed at a position which is in the path of the light beam after passing through the liquid container when the light beam is refracted by liquid in the liquid container.

22. The liquid level monitor of claim 21 wherein the photodetector is disposed at a position which is in a low intensity region of the light beam after passing through the liquid container when the liquid container is empty.

23. The liquid level monitor of claim 22 wherein:
the photodetector produces a first signal in response to being in the path of the light beam after passing through the liquid container when the light beam is refracted by liquid in the liquid container;
the photodetector produces a second signal in response to being in the low intensity region of the light beam after passing through the liquid container when the liquid container is empty; and
the photodetector produces a third signal that is different from the first signal and different from the second signal when the liquid container is not installed.

24. A liquid level monitor for use in conjunction with a liquid container of a liquid-consuming device, the liquid level monitor comprising:
a light source positioned to transmit a light beam into the liquid container of the liquid-consuming device at a non-normal angle of incidence respective to a wall of the liquid container upon which the light beam impinges, wherein the liquid container splits the light beam into a bifurcated intensity distribution; and
a photodetector disposed at a position which is in one lobe of the bifurcated intensity distribution when the light beam passes through liquid in the liquid container.

25. The liquid level monitor of claim 24 wherein the photodetector is disposed at a position which is in a low intensity central region of the bifurcated intensity distribution when the light beam does not pass through liquid in the liquid container.

26. The liquid level monitor of claim 25 wherein:
the photodetector produces a high voltage signal in response to being in the path of the one lobe of the light beam when the light beam passes through liquid in the liquid container; and
the photodetector produces a low voltage signal in response to being in the low intensity central region of the bifurcated intensity distribution when the light beam does not pass through liquid in the liquid container.

27. The liquid level monitor of claim 26 wherein:
the photodetector produces an intermediate voltage signal that is intermediate between the high voltage signal and the low voltage signal in response to being disposed at a position respective to the path of the light beam when the liquid container is not installed.

28. A liquid level monitor comprising:
a dispenser for dispensing hand sanitizer liquid or liquid soap contained in a liquid container configured to connect with the dispenser;
a light source positioned on the dispenser to transmit a light beam into the liquid container of the dispenser at a non-normal angle of incidence respective to a wall of the liquid container upon which the light beam impinges;
a photodetector disposed on the dispenser at a position which is in the path of one of (i) the light beam after passing through the liquid container when the light beam is not refracted by hand sanitizer liquid or liquid soap in the liquid container and (ii) the light beam after passing through the liquid container when the light beam is refracted by hand sanitizer liquid or liquid soap in the liquid container;
at least one electronic processor configured to determine, based on an output of the photodetector, whether the liquid container is empty, not installed, or not empty and to:
display an indication that the liquid container is empty if the electronic processor determines that the liquid container is empty, or
display an indication that the liquid container is not installed if the electronic processor determines that the liquid container is not installed.
